(19) United States
(12) Patent Application Publication
(10) Pub. No.: US 2008/0123629 A1
(43) Pub. Date: May 29, 2008

(54) Apparatus and Method For Automatic Call Back

(75) Inventors: Wi-Sheng Ou Yang, Hsinchu (TW); Tzu-Lang Yang, Hsinchu (TW)

Correspondence Address: WPAT, PC, 7225 BEVERLY ST., ANNANDALE, VA, 22003, US

(73) Assignee: F3 INC., Hsinchu (TW)

(21) Appl. No.: 11/564,391

(22) Filed: Nov. 29, 2006

(51) Int. Cl. H04L 12/66

(52) U.S. Cl. 370/352

(57) ABSTRACT

An apparatus and method for automatic call back are disclosed. When a first communication device requests connection via a first communication network with a higher calling rate, a second communication device of the present invention refuses the connection via the first communication network, but instead, requests communication with the first communication device via a second communication network with a lower calling rate.

### BACKGROUND OF THE INVENTION

1. Field of the Invention

The present invention relates to a cost-saving communication apparatus and method, and more particularly, to a cost-saving communication apparatus and method by automatically calling back.

2. Description of the Prior Art

Telephones and mobile phones are the main media for long-distance communication, the communication method of which is by establishing a communication connection via a telephone network between two communication devices (telephones or mobile phones), such that multimedia data (e.g. images, voices, texts etc.) can be exchanged by the communication connection. Telephone network may include PSTN (public switched telephone network), mobile phone network or any network that can provide direct exchange of multimedia data between phones.

Internet has also become an important medium for long-distance communication apart from telephone network. Two or more communications (e.g. computers, Internet phones etc.) that are capable of running network programs, such as point-to-point software, instant message programs or other network programs for exchanging multimedia data, are able to establish communication connections via the Internet in order to exchange multimedia data.

In terms of the quality of exchanging multimedia data, telephone network is better than the Internet. However, the cost for using the former is higher. Given that the quality is acceptable, using the Internet can save a considerable amount of cost. The calling rates for telephone network are generally divided into long-distance calling rates (including International calling rates) and local calling rates. In general, long-distance calling rates are much higher than the local calling rates. In order to save cost on long-distance calls, Internet plus telephone network schemes have emerged to provide long-distance call services at rates closer to the local calling rates.

Such schemes are commonly seen in two modes: one is by establishing a communication connection by initially a telephone network, the Internet and finally another telephone network; the other is by establishing a communication connection by initially the Internet then a telephone network. For example, as shown in FIG. 1A, a calling party is connected to the Internet 14 by a computer or an Internet phone executing a VoIP/VoIM software 13, and then the Internet 14 is connected to the local telephone network 15 of the receiving party, thereby establishing a communication connection with a telephone 16 of the receiving party, so as to transmit voice, or even images and texts. In this case, the calling party only needs to pay for the cheaper Internet cost plus the local telephone calling cost of the receiving party, which is much cheaper than direct long-distance calls by telephones.

Alternatively, as shown in FIG. 1B, the calling party can make a call from a telephone 12 via a telephone network 15, which is then switched to the Internet 14 by a VoIP/VoIM software 13 and subsequently to the local telephone network 15 of the receiving party, thereby establishing a communication connection with a telephone 16 of the receiving party. In this way, the calling party only needs to pay for the cheaper Internet cost plus the local telephone calling costs of the calling party and the receiving party, which is still cheaper than direct long-distance calls via telephones.

However, these types of cost-saving services may be restricted by the locations of the calling party. For example, when the calling party is overseas with only a mobile phone at hand and no services such as that shown in FIG. 1A or 1B is provided, he/she may have no choice but to make a call from the mobile phone at an expensive global roaming rate.

In view of this, if a national telephone, computer or Internet phone may act as a calling party, then the service shown in FIG. 1A or 1B can be utilized to establish communication, solving the above-described problem.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

In the light of forgoing drawbacks and in order to accommodate the needs of some interests in the industry, an objective of the present invention is to provide an apparatus and method for automatic call back that solves the problems in the traditional cost-saving apparatuses and methods.

Another objective of the present invention is to provide an apparatus and method for automatic call back. When a first communication device requests connection via a first communication network with a higher calling rate, the apparatus for automatic call back of the present invention refuses the connection via the first communication network, but instead, requests communication with the first communication device via a second communication network with a lower calling rate.

Accordingly, the calling party that original requests communication is refused of establishing a communication connection with the receiving party, as a result, the original receiving party becomes the calling party and the original calling party becomes the receiving party. In other words, although communication is requested via the first communication network with a higher calling rate, actual communication with the first communication device is achieved via the second communication network with a lower calling rate.

### BRIEF DESCRIPTION OF THE DRAWINGS

The present invention can be more fully understood by reading the following detailed description of the preferred embodiments, with reference made to the accompanying drawings, wherein:

FIGS. 1A and 1B are schematic diagrams of the prior art;

FIGS. 2A to 2D are function block diagrams illustrating an embodiment of the present invention; and

FIG. 3 is a flow chart of another embodiment of the present invention.

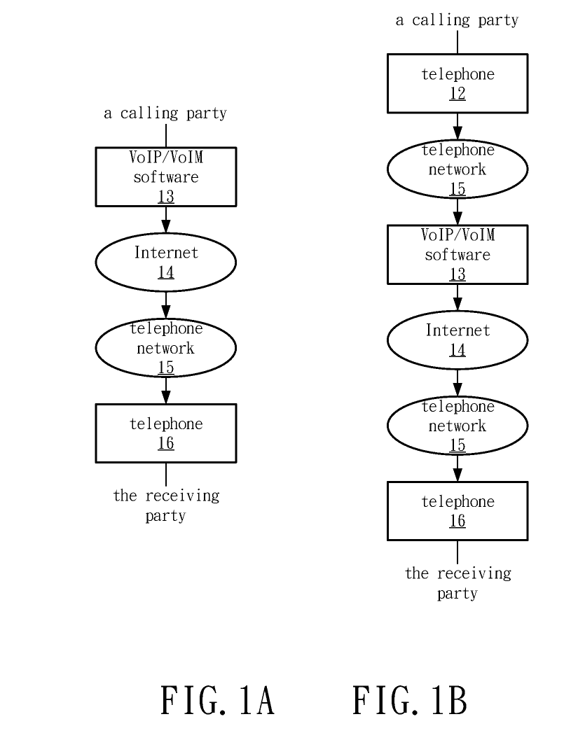

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

The present invention is directed to an apparatus and method for automatic call back. In order to understand the present invention, detailed steps and constructions are set forth in the following descriptions. Apparently, the implementations of the present invention are not limited to the specific details known by those skilled in the art of cost-saving calling apparatus and method. On the other hand, well-known constructions and steps are not described in details in order not to unnecessarily limit the present invention. Preferred embodiments of the present invention will be detailed hereinafter; however, the present invention can be widely applied to other embodiments besides those described herein. The scope of the present invention is therefore not limited by these descriptions but the appended claims.

The present invention provides an apparatus and method for automatic call back. When a calling party dials or transmits requesting message to the apparatus for automatic call back of the present invention, the apparatus for automatic call back of the present invention receives a signal or message request to establish a communication connection, e.g. the apparatus for automatic call back may receive a ringing signal from a telephone network or a message requesting permission to establish a communication network from the Internet. After receiving the requesting signal, the apparatus for automatic call back will refuse communication connection to be established, but acquire some identification information of the calling party from the signal or message sent therefrom, such as the telephone number of the calling party or code of the calling party (e.g. the code used in an instant messenger), so that the apparatus for automatic call back can call back to the original calling party based on the identification information.

The abovementioned call back to the original party not only refers to requesting the original calling party for a communication connection via a telephone network, but also via VoIP/VoIM. For the purpose of clearly distinguishing communication connections in the contents, a communication connection requested by the apparatus for automatic call back to the original calling party is referred to as the first communication connection, whereas a communication connection requested by the original calling part to the apparatus for automatic call back is referred to as the second communication connection. In addition, establishing a communication connection hereinafter means that both parties to which a communication connection is made to may exchange multimedia information via the communication connection. The state of requesting to establish a communication connection should only be regarded as the initialization phase of communication connection where the actual communication connection is not yet established. Moreover, the signal or message sent by the calling party to request the second communication connection to be established will be hereinafter referred to as a request signal.

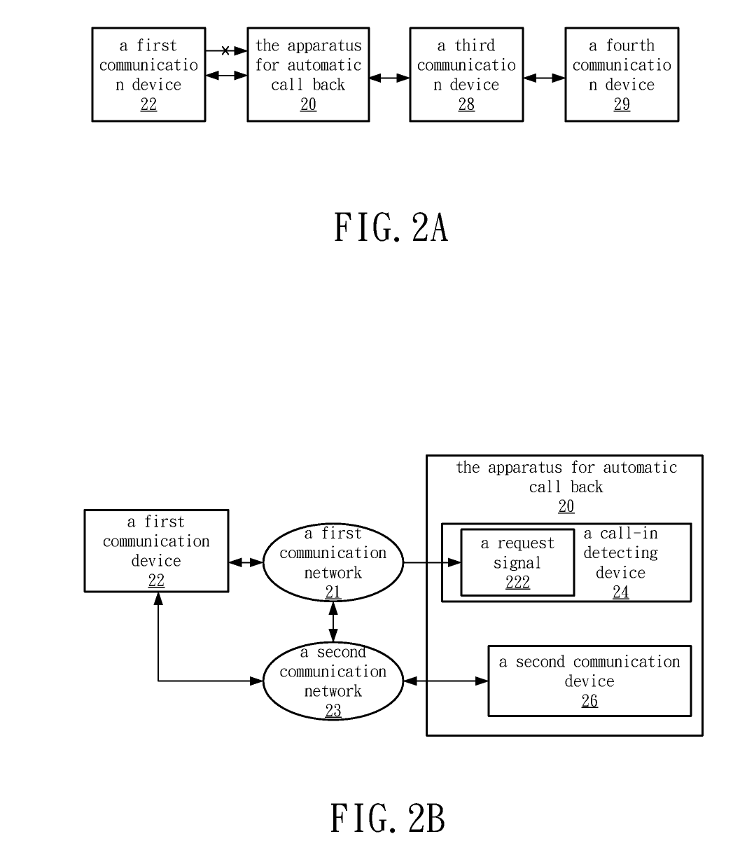

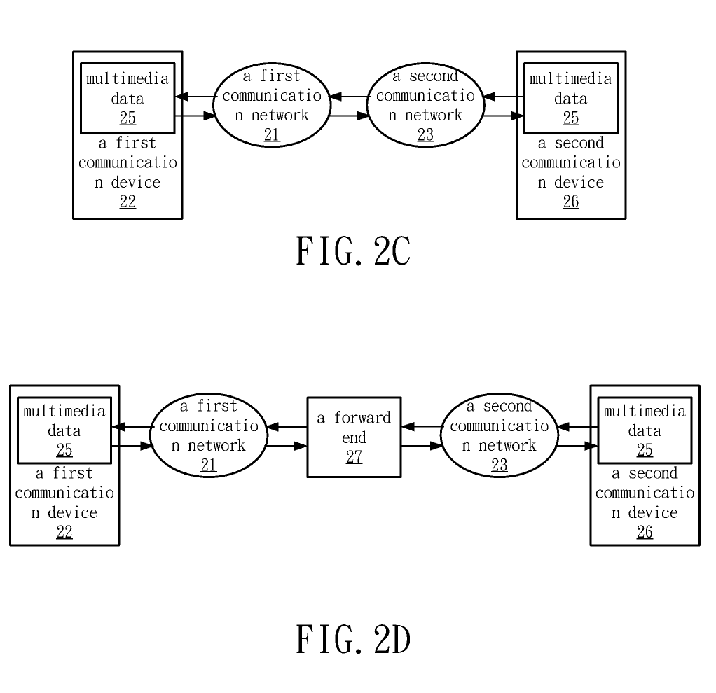

Accordingly, the calling party may request for a second communication connection to be established via a first communication device. After the apparatus for automatic call back refuses to establish the second communication connection, a second communication device then requests the first communication device to establish a first communication connection. In a preferred embodiment of the present invention, as shown in FIG. 2A, the apparatus for automatic call back 20 may also connect to a third communication device 28, such as a telephone. The third communication device 28 sends out indication, such as a ringing of the telephone, based on the request signal sent by the calling party (first communication device 22). The third communication device 28 can be regarded as an extension of the second communication device (included in the apparatus for automatic call back 20). For example, the apparatus for automatic call back 20 is connected to a telephone, and when a remote telephone of a calling party (first communication device 22) sends a request signal to the apparatus for automatic call back 20, the telephone connected to the apparatus for automatic call back 20 starts to ring. As the handset of the phone is picked up or a receiving button thereon is actuated, the apparatus for automatic call back 20 will refuse the request signal of the calling party and allow the second communication device to establish a first communication connection with the telephone at the calling party. At this time, the telephone of the calling party is in communication (exchanging multimedia data) with the telephone connected with the apparatus for automatic call back. In other words, the third communication device is an extension of the second communication device for multimedia input/output.

Moreover, the third communication device 28 can be set up to establish a third communication connection with a fourth communication device 29; that is, the third communication device 28 has a “forward” function. For example, the third communication device 28 may be a telephone (or private branch exchange) with the forward function. When the apparatus for automatic call back 20 receives a request signal, the telephone (third communication device 28) connected with the apparatus for automatic call back 20 dials to the fourth communication device 29 (a remote telephone that is not the original calling party). Once the telephone makes a connection with the remote telephone (third communication connection has been established), the apparatus for automatic call back 20 then refuses the request signal of the original calling party, and allows the second communication device to establish the first communication connection with the original calling party. By now, the third communication connection between the telephone and the remote telephone is an extension of the first communication connection. In other words, after the telephone of the original calling party sends out a request signal (request to establish a second communication connection), the telephone connected with the apparatus for automatic call back 20 first makes a communication connection with the remote telephone (establish a third communication connection) before the apparatus for automatic call back 20 refuses the request signal of the original calling party and allows the second communication device to make a communication with the original calling party (establish the first communication connection). In this case, the original party establishes a communication connection with the remote telephone via the second communication device (first communication connection) and the telephone connected with the apparatus for automatic call back 20 (third communication connection).

In summary, the original calling party first requests communication with the apparatus for automatic call back 20 and is then refused, and then the apparatus for automatic call back 20 calls back the original calling party, such that communication is established between the original calling party and the third communication device 28 connected with the apparatus for automatic call back 20 or between the original calling party and the fourth communication device 29 forwarded by the third communication device 28.

Moreover, the apparatus for automatic call back may establish more than one first communication connections with the original calling party by a switching element that selects one of the first communication connections to exchange multimedia data (communicate). For example, the apparatus for automatic call back may establish a first communication connection by a cheaper communication method (e.g. VoIP/VoIM), and when communication quality goes bad, another communication method (e.g. telephone network) may be used instead to establish a communication connection. These can be done by a switching element. In addition, when the original first communication connection regains good communication quality, the switching element may switch back to it.

Referring to FIG. 2B, a functional block diagram depicting an apparatus for automatic call back 20 according to an embodiment of the present invention is shown. The apparatus 20 comprises a call-in detecting device 24 and a second communication device 26. The call-in detecting device 24 is connected with a first communication network 21 for detecting a request signal 222 sent by a first communication device 22 connected via the first communication network 21. Moreover, the second communication device 26 is connected to a second communication network 23. At least one first communication connection can be established through the second communication network 23 based on the request signal 222. The second communication device 26 exchanges multimedia data 25 via the first communication connection. The multimedia data 25 includes images, voices, texts or other electromagnetic records.

Calling party of the first communication connection is the second communication device 26 connected with the second communication network 23, and the receiving part is the first communication device 22 connected with the first communication network 21. As shown in FIG. 2C, the first communication device above can be a fixed phone, mobile phone, modem, computer, network phone, radio communication device or other communication device that is capable of exchanging multimedia data. The first communication network 21 can be a telephone network or the Internet. The second communication network 23 can also be a telephone network or the Internet. The first communication network 21 can be connected with the second communication network 23 or there may be other communication network(s) connected between the first communication network 21 and the second communication network 23, the present invention is not limited to these.

Therefore, as shown in FIG. 2D, the first communication connection may comprise a forward end 27. The second communication device 26 exchanges multimedia data 25 with the forward end 27 via the second communication network 23, and then the forward end 27 exchanges multimedia data 25 with the first communication device 22 via the first communication network 21, thus achieving connection between the first communication network 21 and the second communication network 23.

Moreover, when the first communication network 21 or the second communication network 23 is the Internet, the first communication device 22 or the second communication device 26 connected to the Internet comprises a software, which may be executed by the first communication device 22 or the second communication device 26 in order to exchange the multimedia data 25 via the first communication connection. Thus, when the first communication network 21 is the Internet, request signal 222 can be transmitted by the call-in detecting device 24 to the software of the second communication device 26, that is, the request signal 222 is received by the software of the second communication device 26. The call-in detecting device 24 may detect the request signal 222 by monitoring the software of the second communication device 26 or packets sent from the Internet.

The above multimedia data exchange through the Internet may be conform to one of the following communication protocols: H.323, SIP (Session Initiation Protocol), H. 248 or the like. Alternative, it can conform to a protocol that runs on the abovementioned protocols, such as VoIP (Voice over Internet Protocol) or VoIM (Voice over Instant Messenger). Obviously, these protocols can be easily derived from those skilled in the related arts. The abovementioned software can be a point-to-point communication software used for IP phones or instant messenger software, such as Yahoo messenger, ICQ, MSN, Google Talk etc.; the present invention is not limited to these.

There can be a plurality of the above first communication connection. Each of the first communication connections may be established through a different first communication network 21 or second communication network 23. For example, the calling party of a first of the first communication connection may be the second communication device connected to the Internet and the receiving party thereof may be the first communication device connected to a telephone network. While the calling party of a second of the first communication connection may be the second communication device connected to a telephone network and the receiving party thereof may be the first communication device connected to a telephone network. While the calling party of a third of the first communication connections may be the second communication device connected to a telephone network and the receiving party thereof may be the first communication device connected to a telephone network and so forth. When the first and second communication network are both Internet or telephone network, they can be regarded as the same Internet or telephone network.

The second communication device 26 may comprise a lookup table. The second communication device 26 looks up the table according to the request signal 222, and establishes a first communication connection based on the result of the lookup. For example, when the first communication network 21 is a telephone network, the request signal 222 may comprise the telephone number of the calling party (first communication device 22); when the first communication network 21 is the Internet, the request signal 222 may comprise an identification code, which may be selected from the group consisting of IP address, MAC address and identification of instant messenger. The table is looked up using the telephone number or the identification code to obtain one or more results. The second communication device 26 establishes a first communication connection according to the result.

In this connection, the present embodiment may comprise an establishing element, a switching element and a display element. The establishing element controls the establishment of the first communication connection. Each time the establishing element is actuated, the second communication device 26 establishes a new first communication connection. In a preferred example of the present invention, the second communication device 26 exchanges multimedia data 25 via the newly established first communication connection. Furthermore, every time the switching element is actuated, the switching element selects one of first communication connections, which will be used by the second communication device 26 to exchange multimedia data 25. In addition, the display element displays the connection quality of each first communication connection that is used as a reference for selecting a first communication connection to exchange multimedia data 25.

Therefore, when the establishing element is actuated, the second communication device 26 looks up the table according to the request signal 222 (e.g. telephone number or identification code) to obtain a result for establishing a first communication connection. The result of the lookup can be used to restrict the establishment of the first communication connection, for example, the request signal 222 may not be authorized to establish a first communication connection. The lookup result may also indicate a second communication network 23 for hooking up the first communication connection and the way of establishing the first communication connection with the first communication device 22. Consequently, based on the lookup result, for example, the telephone number indicating the first communication device 22 is dialed via the telephone network or the IP address, MAC address or instant messenger ID code indicating the first communication device 22 is used to establish the first communication connection via the Internet.

Accordingly, the establishing element allows the second communication device 26 to establish one or more first communication connections via the same or different second communication network 23. For example, the first communication device 22 may be a communication device that can be simultaneously connected to telephone network and Internet. When the establishing element is initially actuated, the second communication device 26 may establish a first of the first communication connection with the first communication device 22 for exchanging multimedia data 25. If the quality of communication of the first of the first communication connection is indicated to be poor by the display element, then the establishing element is again actuated and so is the switching element, such that the second communication device 26 may establish a second of the first communication connection with the first communication device 22 for exchanging multimedia data 25. The first of the first communication connection for exchanging multimedia data can be selected again by actuating the switching element once its communication quality indicated by the display element becomes good. Meanwhile, the second of the first communication connection can be cut off to save cost.

In a preferred example of the present embodiment, the establishing element and the switching element may be actuated by a single button or individual buttons. For example, in the case of the second communication device 26 including only one button, when the call-in detecting device 24 detects a request signal 222, the button is actuated for the first time, which triggers the establishing element to establish a first communication connection. When the button is actuated for the second time, the establishing element is triggered again to establish another first communication connection, which is used by the second communication device for exchanging multimedia data. After the second actuation, each actuation thereafter will trigger the switching element instead of the establishing element.

The present embodiment may further comprise a third communication device, which makes a ringing sound upon detection of the request signal 222 by the call-in detecting device 24 and exchanges multimedia data 25 with the second communication device 26. The third communication device may stop ringing when the second communication device 26 starts to exchange multimedia data 25. For example, the third communication device may be a telephone that starts ringing when the call-in detecting device 24 detects the request signal 222 and exchanges multimedia data 25 with the second communication device 26 when getting through (e.g. handset being picked up or communication button being pressed), that is, the third communication device exchanges multimedia data 25 with the first communication device 22 via the second communication device 26.

Moreover, the third communication device may establish a third communication connection with a fourth communication device upon detection of the request signal 222 by the call-in detecting device 24, in which the fourth communication device is able to exchange multimedia data 25 with the third communication device, which in turns exchange multimedia data 25 with the second communication device 26 upon establishment of the third communication connection. In other words, the fourth communication device exchanges multimedia data 25 with the first communication device 22 via the third communication device and the second communication device 26. For example, the fourth communication device is a telephone, which upon getting through makes a third communication connection with the third communication device. The third communication device establishes the third communication connection with the telephone via a telephone network.

In a preferred example of the present embodiment, the first communication device 22 and the third communication device are both telephones. When the first communication device 22 requests to establish a second communication connection with the call-in detecting device 24 via a telephone network, the third communication device starts to ring. When the third communication device gets through, the second communication device 26 establishes a first communication connection, so that the third communication device can exchange multimedia data 25 with the first communication device 22 via the first communication connection. The above second communication connection is not established. Since most telephone networks do not charge when a call is being made but not yet picked up by a receiving party, so cost will not be incurred when using these kinds of telephone networks to send request signals 222.

In another preferred example of the present embodiment, the first communication device 22, the third communication device and the fourth communication device are all telephones. When the first communication device 22 requests to establish a second communication connection with the call-in detecting device 24 via a telephone network, the third communication device dials to the fourth communication device. Once the fourth communication device gets through, so does the third communication device, which establishes a third communication connection with the fourth communication device. Meanwhile, the second communication device 26 establishes a first communication connection, such that the fourth communication device exchanges multimedia data 25 with the first communication device 22 via the first communication connection and the third communication connection.

In addition, the call-in detecting device 24 may further refuse the establishment of the second communication connection after detecting the request signal 222, such as by cutting off the connection with the first communication network, to avoid the communication function of the first communication device 22 being occupied (e.g. maintained in the dialing state) and disturbs the establishment of the first communication connection by the second communication device 26 (e.g. connection failed due to the first communication device 22 is dialing i.e. occupied).

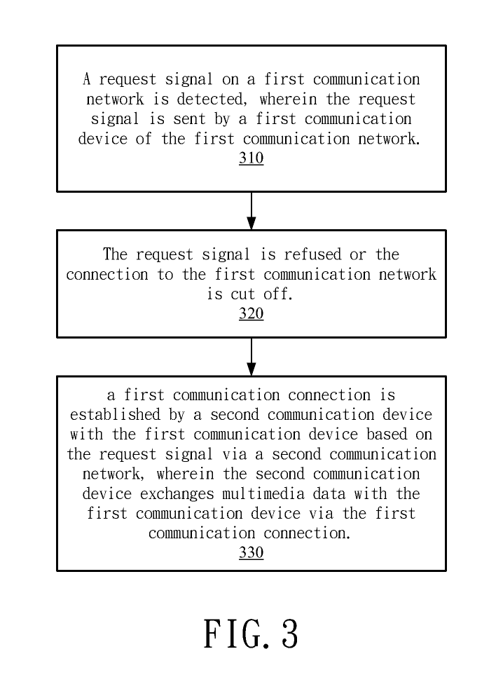

In summary, another embodiment of the present invention comprises a method for automatic call back, as shown in FIG. 3. First, in step 310, a request signal 222 on a first communication network 21 is detected, wherein the request signal 222 is sent by a first communication device 22 of the first communication network 21. Then, in step 320, the request signal 222 is refused or the connection to the first communication network 21 is cut off. Subsequently, in step 330, a first communication connection is established by a second communication device 26 with the first communication device 22 based on the request signal 222 via a second communication network 23, wherein the second communication device 26 exchanges multimedia data 25 with the first communication device 22 via the first communication connection. The multimedia data can be selected from one of the group consisting of images, voices and texts. Other relevant details of this present embodiment have already been described above and are not repeated.

Obviously, according to the descriptions of the above embodiments, various modifications and alternatives of the present invention may be implemented. Besides the above detailed descriptions, the present invention can be broadly applied in other embodiments and the scope of the appended claims should thus be comprehended. The above embodiments are only used to illustrate the principles of the present invention, and they should not be construed as to limit the present invention in any way. The above embodiments can be modified by those with ordinary skills in the arts without departing from the scope of the present invention as defined in the following appended claims.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

What is claimed is:

1. An apparatus for automatic call back, comprising:
a call-in detecting device connected with a first connection network for detecting a request signal sent by a first communication device connected to the first connection network; and
a second communication device connected with a second connection network for establishing at least one first communication connection via the second communication network based on the request signal, wherein the second communication device exchanges multimedia data with the first communication device through the first communication connection.

2. The apparatus for automatic call back of claim 1, wherein the second communication device further includes a lookup table that can be looked up by the second communication device according to the request signal, and the at least one first communication connection is established based on the result of look up.

3. The apparatus for automatic call back of claim 1, wherein the request signal is generated when the first communication device connected with the first communication network requests the call-in detecting device to establish a second communication connection, and the second communication device establishing the at least one first communication connection with the first communication device.

4. The apparatus for automatic call back of claim 1, wherein one end of the first communication connection is connected to the second communication device of the second communication network, while the other end is connected to the first communication device of the first communication network.

5. The apparatus for automatic call back of claim 1, wherein the first communication connection connects the first communication device via the second communication network and the first communication network.

6. The apparatus for automatic call back of claim 1, wherein the first communication network is a telephone network.

7. The apparatus for automatic call back of claim 1, wherein the first communication network is Internet, and the second communication device further including a software that can be executed by the second communication device in order to receive the request signal via the call-in detecting device.

8. The apparatus for automatic call back of claim 1, wherein the second communication network is Internet, and the second communication device further including a software that can be executed by the second communication device in order to establish the first communication connection.

9. The apparatus for automatic call back of claim 1, wherein the second communication network is a telephone network.

10. The apparatus for automatic call back of claim 1, wherein the exchange of multimedia data is based on a protocol selected from the group consisting of Voice over Internet Protocol (VoIP) and Voice over Instant Messenger (VoIM).

11. The apparatus for automatic call back of claim 1, wherein the exchange of multimedia data is based on a protocol selected from the group consisting of H.323, Session Initiation Protocol and H.248.

12. The apparatus for automatic call back of claim 1, wherein the second communication device further includes a establishing element for controlling the establishment of the at least one first communication connection, the second communication device establishing a new first communication connection upon actuation of the establishing element, via which multimedia data is exchanged.

13. The apparatus for automatic call back of claim 12, wherein the second communication device further includes a switching element, upon actuation of which, the second communication device selecting one of other first communication connections for multimedia data exchange.

14. The apparatus for automatic call back of claim 13, wherein the second communication device further includes a display element for displaying communication quality of each of the first communication connections to be used as reference for selecting a first communication connection for multimedia data exchange.

15. The apparatus for automatic call back of claim 14, wherein the second communication device further includes a button, which is activated for the first time when the call-in detecting device detecting the request signal, so as to trigger the establishing element to establish one of the at least one first communication connection; the button being activated for the second time along with the establishing element and the switching element to establish another one of the at least one first communication connection, the second communication device switching to exchange multimedia data via the another one of the at least one first communication connection; every activation of the button after the second activation triggering only the switching element.

16. The apparatus for automatic call back of claim 1, further including a third communication device which starts to make a ringing sound when the call-in detecting device detects the request signal, exchanges multimedia data with the second communication device, wherein the ringing sound stops when the third communication device starts to exchange multimedia data with the second communication device.

17. The apparatus for automatic call back of claim 16, wherein the third communication device is a telephone which starts to make a ringing sound when the call-in detecting device detects the request signal, exchanges multimedia data with the second communication device when being picked up.

18. The apparatus for automatic call back of claim 16, wherein when the call-in detecting device detects the request signal, the third communication device establishes a third communication connection with a fourth communication device that exchanges multimedia data with the third communication device that in turns exchanges the multimedia data with the second communication device when the third communication connection is established.

19. The apparatus for automatic call back of claim 18, wherein the fourth communication device is a telephone, when being picked up, establishing the third communication connection with the third communication device via a telephone network.

20. The apparatus for automatic call back of claim 1, wherein the multimedia data is at least one selected from the group consisting of images, voices and texts.

21. A method for automatic call back, comprising:
detecting a request signal from a telephone network, wherein the request signal is sent from a first communication device connected with the telephone network;
refusing the request signal; and
establishing a first communication connection by a second communication device with the first communication device based on the request signal via the telephone network, wherein the second communication device exchanges multimedia data with the first communication device via the first communication connection, wherein the multimedia data is at least one selected from the group consisting of images, voices and texts.

22. The method for automatic call back of claim 21, wherein the first communication device is selected from the group consisting of fixed telephone, mobile telephone and modem.

23. A method for automatic call back, comprising:
detecting a request signal from a first communication network, wherein the request signal is sent from a first communication device connected with the first communication network;
actuating a telephone to ring based on the request signal;
refusing the request signal;
establishing at least one first communication connection by a second communication device with the first communication device based on the request signal via a second communication network and the first communication network; and
exchanging multimedia data between the telephone and the first communication device via the second communication device over the first communication connection, wherein the multimedia data is at least one selected from the group consisting of images, voices and texts.

24. The method for automatic call back of claim 23, wherein the first communication network and the second communication network are a telephone network and Internet, respectively, and the first communication connection being achieved through the Internet connected with the telephone network.

25. The method for automatic call back of claim 23, wherein the first communication network and the second communication network are telephone networks.
